(19) United States
(12) Patent Application Publication
(10) Pub. No.: US 2004/0265662 A1
(43) Pub. Date: Dec. 30, 2004

(54) System and method for heat exchange using fuel cell fluids

(76) Inventors: Cyril Brignone, Beauvoir (FR); Ratnesh Sharma, Union City, CA (US); Salil Pradhan, Santa Clara, CA (US); Malena Mesarina, Menlo Park, CA (US); Cullen E. Bash, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/611,166

(22) Filed: Jun. 30, 2003

(51) Int. Cl. H01M 8/04

(52) U.S. Cl. 429/26; 429/38; 429/25; 429/24; 429/13

(57) ABSTRACT

A system and method for heat exchange is disclosed. The system discloses: a device within a server rack having a first temperature; fuel cell fluid having a second temperature differing from the first temperature by a temperature difference; a fuel cell within the server rack from which electrical power can be generated; a fluid manifold coupling the fuel cell fluid to the fuel cell; and a heat exchanger thermally coupling the fuel cell fluid to the device, whereby the temperature difference is decreased. The method discloses: monitoring a device within a server rack having a first temperature; monitoring a fuel cell fluid having a second temperature differing from the first temperature by a temperature difference; coupling the fuel cell fluid to a fuel cell within the server rack for generating electrical power; and exchanging thermal energy between the fuel cell fluid and the device, whereby the temperature difference is modulated.

### CROSS-REFERENCE TO CO-PENDING APPLICATIONS

This application relates to co-pending U.S. patent application Ser. No. 10/425,169, entitled “System And Method For Providing Electrical Power To An Equipment Rack Using A Fuel Cell,” filed on Apr. 29, 2003, by Brignone et al., U.S. patent application Ser. No. 10/425,902, entitled “Electrically Isolated Fuel Cell Powered Server,” issued on Apr. 29, 2003, by Lyon et al, and U.S. patent application Ser. No. 10/425,763, entitled “System And Method For Managing Electrically Isolated Fuel Cell Powered Devices Within An Equipment Rack,” issued on Apr. 29, 2003, by Lyon et al. These related applications are commonly assigned to Hewlett-Packard of Palo Alto, Calif.

### BACKGROUND OF THE INVENTION

1. Field of the Invention

The present invention relates generally to systems and methods for heat exchange, and more particularly to heat exchange using fuel cell fluids.

2. Discussion of Background Art

Modern service and utility based computing is increasingly driving enterprises toward consolidating large numbers of computer servers, such as blade servers, and their supporting devices into massive data centers. A data center is generally defined as a room, or in some cases, an entire building or buildings, that houses numerous printed circuit (PC) board electronic systems arranged in a number of racks. Such centers, of perhaps fifty-thousand nodes or more, require that such servers be efficiently networked, powered, and cooled.

Typically such equipment is physically located within a large number of racks. Multiple racks are arranged into a row. The standard rack may be defined according to dimensions set by the Electronics Industry Association (EIA) for an enclosure: 78 in. (2 meters) wide, 24 in. (0.61 meter) wide and 30 in. (0.76 meter) deep.

Standard racks can be configured to house a number of PC boards, ranging from about forty (40) boards, with future configuration of racks being designed to accommodate up to eighty (80) boards. Within these racks are also network cables and power cables. The PC boards typically include a number of components, e.g., processors, micro-controllers, high-speed video cards, memories, and semi-conductor devices, that dissipate relatively significant amounts of heat during the operation. For example, a typical PC board with multiple microprocessors may dissipate as much as 250 W of power. Consequently, a rack containing 40 PC boards of this type may dissipate approximately 10 KW of power.

Generally, the power used to remove heat generated by the components on each PC board is equal to about 10 percent of the power used for their operation. However, the power required to remove the heat dissipated by the same components configured into a multiple racks in a data center is generally greater and can be equal to about 50 percent of the power used for their operation. The difference in required power for dissipating the various heat loads between racks and data centers can be attributed to the additional thermodynamic work needed in the data center to cool the air. For example, racks typically use fans to move cooling air across the heat dissipating components for cooling. Data centers in turn often implement reverse power cycles to cool heated return air from the racks. This additional work associated with moving the cooling air through the data center and cooling equipment, consumes large amounts of energy and makes cooling large data centers difficult.

In practice, conventional data centers are cooled using one or more Computer Room Air Conditioning units, or CRACs. The typical compressor unit in the CRAC is powered using a minimum of about thirty (30) percent of the power required to sufficiently cool the data centers. The other components, e.g., condensers, air movers (fans), etc., typically require an additional twenty (20) percent of the required cooling capacity.

As an example, a high density data center with 100 racks, each rack having a maximum power dissipation of 10 KW, generally requires 1 MW of cooling capacity. Consequently, air conditioning units having the capacity to remove 1 MW of heat generally require a minimum of 300 KW to drive the input compressor power and additional power to drive the air moving devices (e.g., fans and blowers).

One problem with conventional systems is that each equipment rack's power needs can vary substantially, depending upon: how many servers or other devices are located in the rack; and whether such devices are in a standby mode or are being fully utilized. While central high-voltage/current power sources located elsewhere in the data center can provide the necessary power, the aforementioned power consumptions variations often result in greater overall data center transmission line losses, and more power-line transients and spikes, especially as various rack equipment goes on-line and off-line. Due to such concerns, power-line conditioning and switching equipment is typically added to each rack, resulting in even greater heat generation.

Reliance on central power systems also subjects the racks to data center wide power failure conditions, which can result in disruptions in service and loss of data. While some equipment racks may have a battery backup, such batteries are designed to preserve data and permit graceful server shutdown upon experiencing a power loss. The batteries are not designed or sized for permitting equipment within the rack to continue operating at full power though.

Each equipment rack's cooling needs can also vary substantially depending upon how many servers or other devices are located in the rack, and whether such devices are in a standby mode, or being fully utilized. Central air conditioning units located elsewhere in the data center provide the necessary cooling air, however, due to the physical processes of ducting the cooling air throughout the data center, a significant amount of energy is wasted just transmitting the cooling air from the central location to the equipment in the racks. Cabling and wires internal to the rack and under the data center floors blocks much of the cooling air, resulting in various hot-spots that can lead to premature equipment failure.

As implied above, the removal of heat is thus an important function of most data center environmental control systems, and systems and methods which can efficiently manage excess heat are very useful.

In response to the concerns discussed above, what is needed is a system and method for heat exchange improves upon current systems within the art.

### SUMMARY OF THE INVENTION

The present invention is a system and method for heat exchange using fuel cell fluids. The system of the present invention includes: a device within a server rack which has a first temperature; fuel cell fluid which has a second temperature differing from the first temperature by a temperature difference; a fuel cell within the server rack from which electrical power can be generated; a fluid manifold coupling the fuel cell fluid to the fuel cell; and a heat exchanger thermally coupling the fuel cell fluid to the device, whereby the temperature difference is decreased.

The method of the present invention includes the elements of: monitoring a device within a server rack having a first temperature; monitoring a fuel cell fluid having a second temperature differing from the first temperature by a temperature difference; coupling the fuel cell fluid to a fuel cell within the server rack for generating electrical power; and exchanging thermal energy between the fuel cell fluid and the device, whereby the temperature difference is modulated.

These and other aspects of the invention will be recognized by those skilled in the art upon review of the detailed description, drawings, and claims set forth below.

### BRIEF DESCRIPTION OF THE DRAWINGS

FIG. 1 is a block diagram of a first embodiment of a system for heat exchange using fuel cell fluids within an equipment rack;

FIG. 2 is a block diagram of a second embodiment of the system;

FIG. 3 is a block diagram of a third embodiment of the system;

FIG. 4 is a block diagram of a fourth embodiment of the system; and

FIG. 5 is a flowchart of one embodiment of a method for heat exchange using fuel cell fluids within the equipment rack.

### DESCRIPTION OF THE PREFERRED EMBODIMENT

The present invention in one embodiment uses fuel cell technology: to reduce or eliminate reliance on a central power source; to cool various devices, including servers, within the rack directly, using fuel cell liquids, such as methanol; and to recover otherwise wasted heat in order to improve fuel cell operating efficiency. All of these capabilities make the present invention particularly advantageous over the prior art.

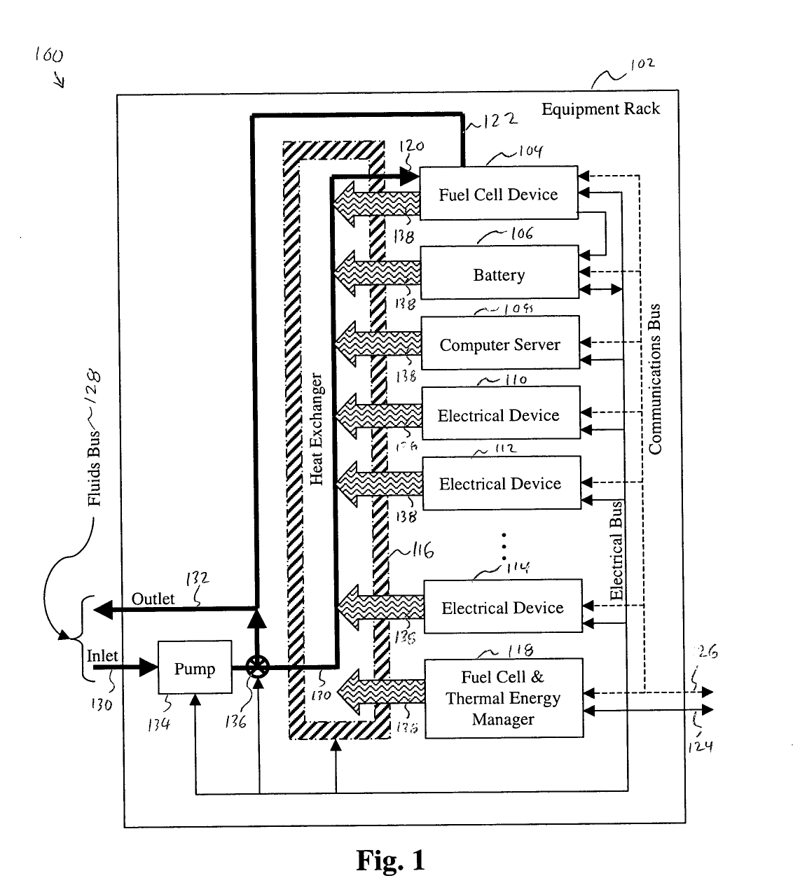

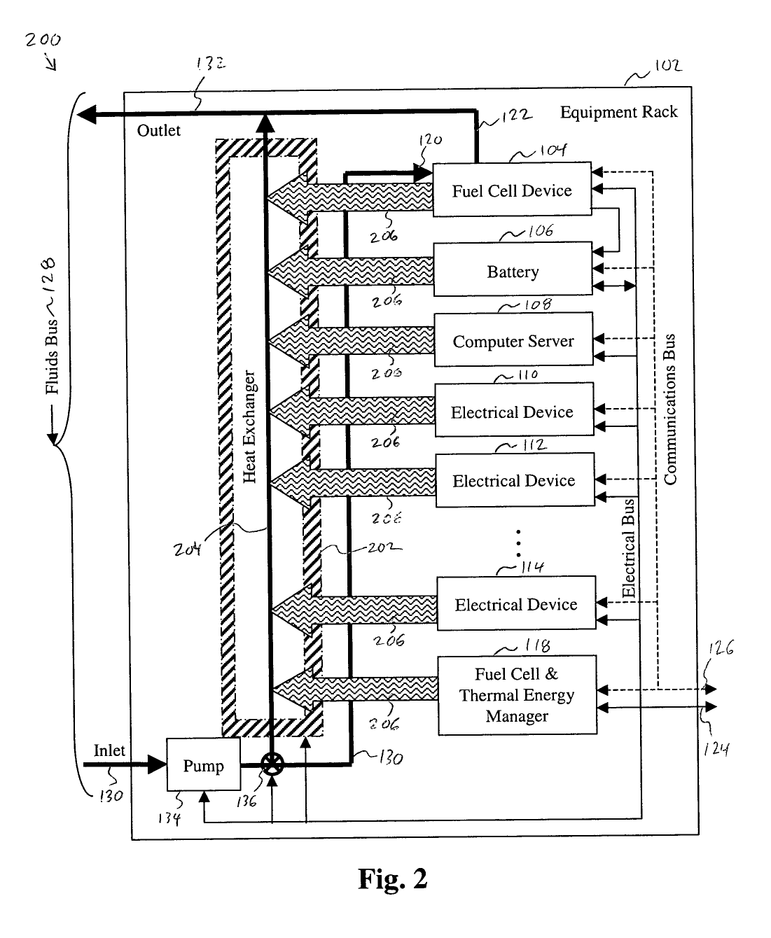

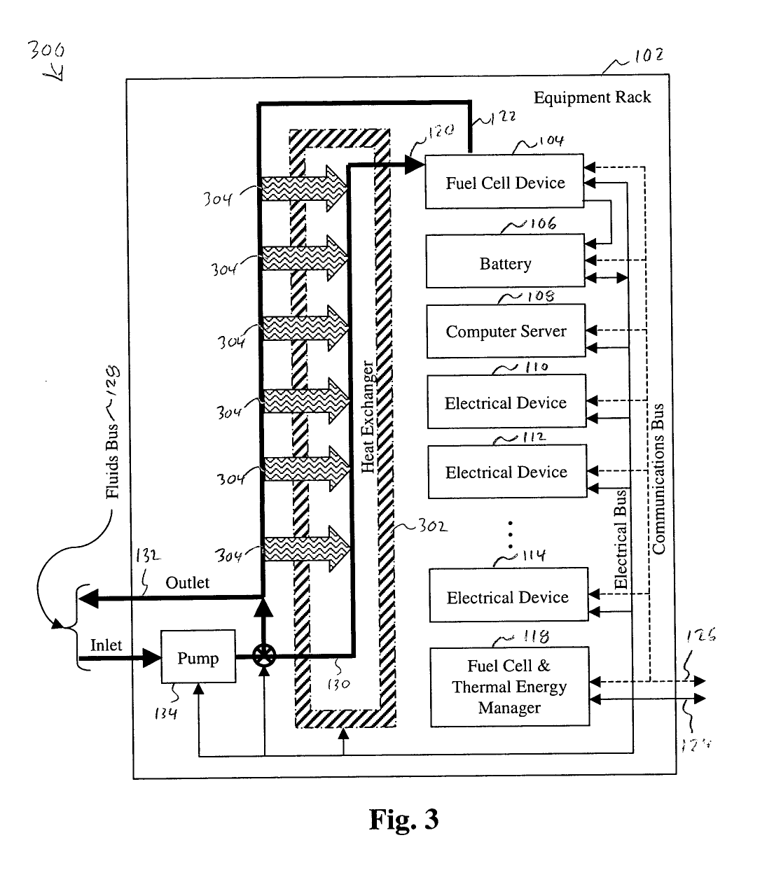

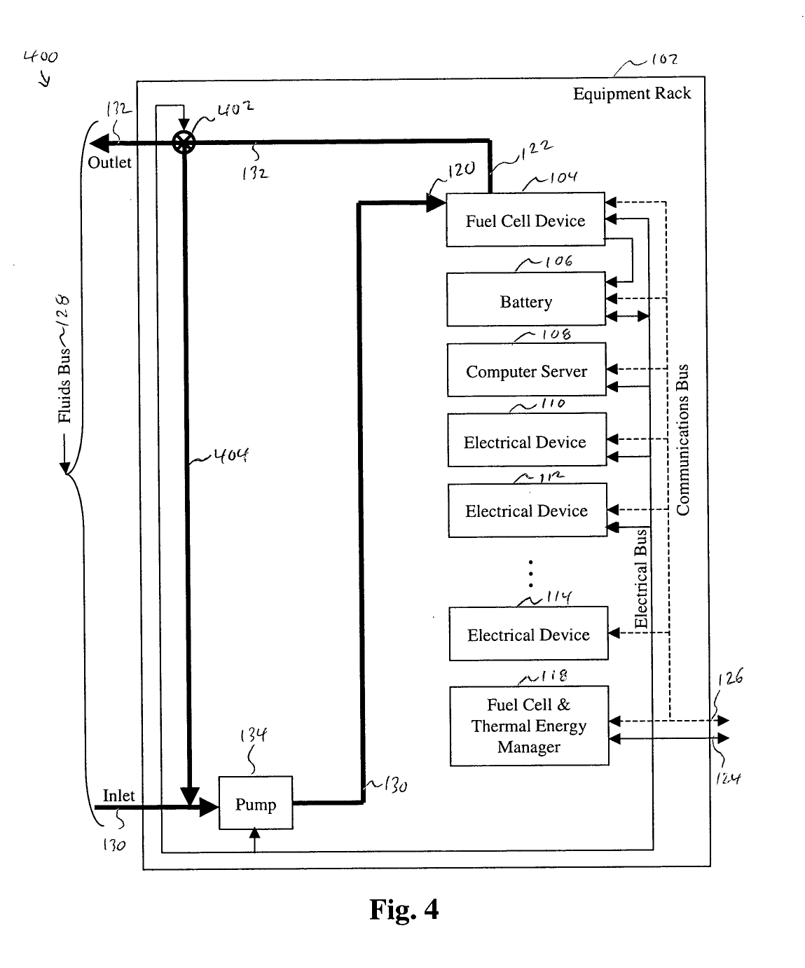

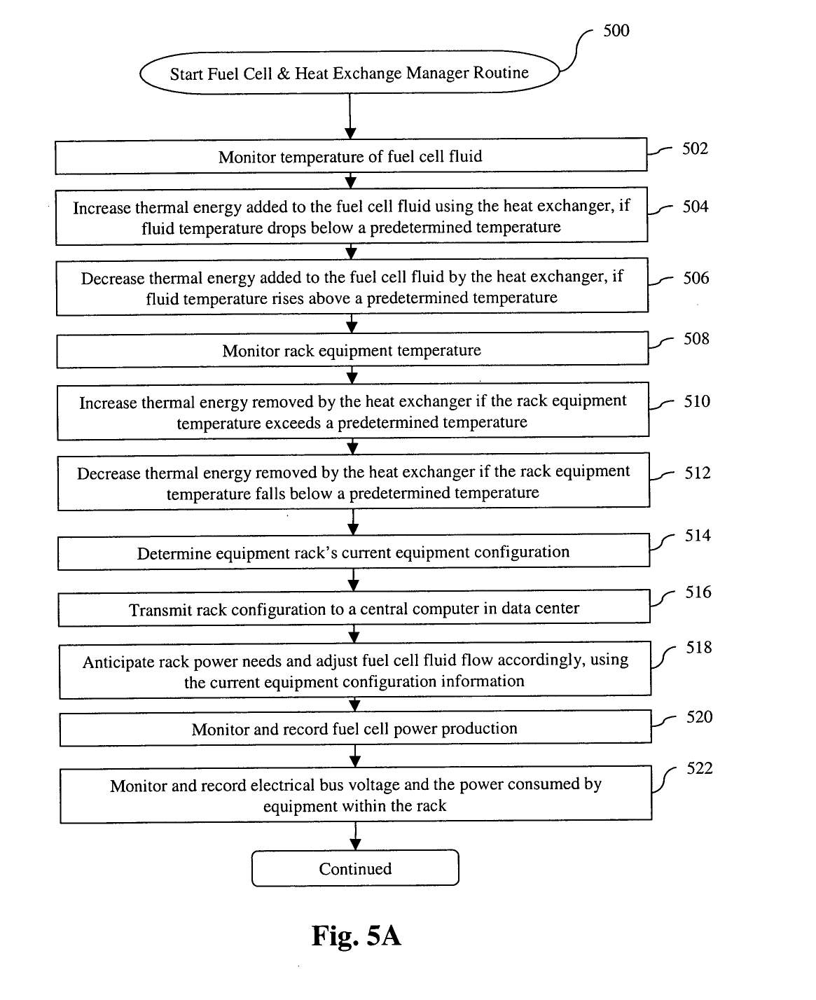

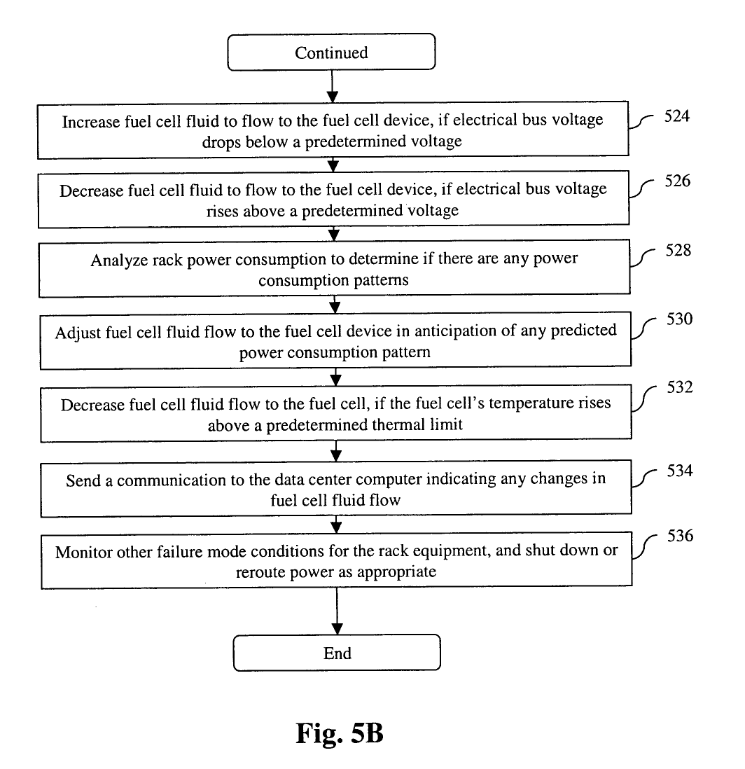

FIG. 1 is a block diagram of a first embodiment 100 of a system for heat exchange using fuel cell fluids within an equipment rack 102. FIG. 2 is a block diagram of a second embodiment 200 of the system. FIG. 3 is a block diagram of a third embodiment 300 of the system. FIG. 4 is a block diagram of a fourth embodiment 400 of the system. FIG. 5 is a flowchart of one embodiment of a method 500 for heat exchange using fuel cell fluids within the equipment rack 102. FIGS. 1 through 5 are now discussed together.

The equipment rack 102 refers generally to any structure able to hold a variety of electrical and non-electrical equipment/devices. Thus, the equipment rack 102 could alternatively be labeled a device rack. If most of the devices/equipment within the rack 102 are servers, the equipment/device rack 102 could alternatively be called a server rack. For the purposes of this discussion the term device is herein defined to be more general than the term sever.

The equipment rack 102, in the one embodiment discussed herein, is presumed to be located within a data center (not shown) of a predetermined size. The data center includes a variety of centralized resources, and stores, which are discussed below as needed. Those skilled in the art however will know that the rack 102 could alternatively be located in a variety of other non-data center environments.

The rack 102 in the one embodiment of the present invention, shown in FIG. 1, includes a fuel cell device 104, a battery 106, an computer server 108, a set of electrical devices 110 through 114, a first, second and third embodiment of a heat exchanger 116, 202, and 302, and a fuel cell & thermal energy manager 118. Those skilled in the art will recognize that the number of devices and servers in the rack 102 can vary with each different implementation of the present invention.

The fuel cell device 104, which in a more narrow embodiment can be a fuel cell powered server, preferably includes and is powered by a Direct Methanol Fuel Cell (DMFC). However, those skilled in the art recognize that other non-methanol fuel cells may work as well. The DM fuel cell includes a hydrogen circuit and an oxidizer circuit separated by a semi-permeable catalytic membrane. It is the interaction between the hydrogen and the oxidizer across the membrane which produces current flow and thus electrical power from the DM fuel cell. On the hydrogen circuit side of the membrane, a mixture of methanol and water enter into the DM fuel cell, while a mixture of methanol, water, and carbon dioxide exit. On the oxidizer circuit side of the membrane, an oxidizer, such as oxygen enters the DM fuel cell, while a mixture of oxygen, water, and nitrogen exit. The gases exiting the oxidizer circuit are typically vented to the air, while the water is mixed back in with the water and methanol exiting the hydrogen circuit side of the membrane.

Thus, the fuel cell device 104 incorporating a DM fuel cell requires at least two fluid ports, an input port 120 for receiving the incoming methanol/water mixture and an output port 122 for exhausting the outgoing methanol, carbon dioxide, and water mixture.

Electrical power generated by the fuel cell device 104 is preferably regulated in part by the battery 106, since the fuel cell's 104 output voltage is not easy to directly regulate. The battery 106 in turn supplies electrical power to other equipment within the rack 102 over an electrical bus 124. The fuel cell & thermal energy manager 118 also helps regulate the electrical bus 124 voltage by monitoring and controlling how much power is consumed by equipment within the rack 102, how much power is generated by the fuel cell device 104, and the battery's 106 charge/discharge rate. In an alternate embodiment, the electrical power generated by the fuel cell device 104 can be used only to power the fuel cell device 104 itself, and additional electrical power can be supplied over the electrical bus 124 from sources external to the rack 102 as needed.

A communications bus 126 routes data between the server, devices, and manager, as well as between the rack 102 and the rest of the data center. Preferably the communications bus 126 includes a fiber optic cable, so as to minimize the number of electrical paths within the equipment rack and thus not be as affected by any fluid leaks from the fuel cell device 104. However, the communications bus 126 could also be of another type.

A fluids bus 128, external to the rack 102, routes incoming and outgoing fluids to the rack 102 from the data center's centralized fluid stores and repositories. The fluids bus 128 connects to a fluid manifold within the rack 102. Since the fuel cell device 104 as discussed herein, preferably is powered by a methanol based fuel cell, the manifold includes a methanol inlet conduit 130, a methanol outlet conduit 132, and a valve 136. Those skilled in the art will recognize that other embodiments of the present invention may use different fuel cell technology, which require a different, but functionally equivalent, fluid manifold. The inlet conduit 130 routes methanol to the input port 120 on the fuel cell device 104 and the outlet conduit 132 routes methanol from the output port 122 on the fuel cell device 104. Each conduit is preferably coupled to the ports 120 and 122 using leak-resistant no-drip connectors.

The inlet conduit 130 preferably includes a pump 134 and a bypass control valve 136. The pump 134 is used to maintain fluid pressure within the inlet conduit 130. The bypass control valve 136 preferably shunts the input fluid should fluid pressure be too high. The valve 136 is preferably a three-way valve having an input port, an output port, and a bypass port. The input port of the valve 136 receives incoming fluids from the fluid manifold's inlet conduit 130. The output port of the valve 136 connects to the fuel cell's 104 input port 120. The bypass port of the valve 136 connects to the fluid manifold's outlet conduit 132.

The valve is continuously adjustable from a fully-open and to a fully-closed position. When the valve is fully-open, all incoming fluids are routed to the fuel cell input port 120. However, when the valve is fully-closed, all incoming fluids bypass the fuel cell and are routed to the fluid manifold's outlet conduit 132.

In an alternate embodiment just the bypass control valve 136 can be used to regulate fluid pressure at the input port 120, without the pump 134. In such an embodiment, fluid pressure on the fluids bus 128 is maintained at a predetermined pressure higher than a maximum pressure required at the fuel cell device 104 input port 120. The bypass control valve would then continually bypass a predetermined amount of fluid from the inlet conduit 130 to the outlet conduit 132 in order to maintain a required pressure at the input port 120 of the fuel cell device 104.

Both the pump 134 and the valve 136 are preferably coupled to and controlled by the manager 118 via the electrical bus 124. The manager 118 can thus control how much electricity the fuel cell device 104 produces. Specifically, the fuel cell device 104 produces more electricity when supplied with more fuel cell fluid, and less electricity, if fuel cell fluid is restricted.

During normal fuel cell and equipment rack 102 operation, a significant quantity of heat is generated and must be removed so that neither the fuel cell nor equipment within the rack 102 overheats. The fuel cell fluid entering from the fluid bus 128 is thus preferably cooled to a predetermined temperature so that when passed through either the first 116 or second 202 embodiments of the heat exchanger, respectively shown in FIGS. 1 and 2, sinks heat 138 from equipment within the rack 102 and prevents overheating. Methanol is one of the preferred fuel cell device 104 fluids since methanol can readily function as both a hydrogen source for the fuel cell device 104 and as a coolant for the rack 102. Cool methanol passing through the fluid bus 128 also reduces the methanol's volatility, thereby lessening chances that the methanol will ignite or excessively evaporate as the methanol is routed through the data center. Direct methanol fuel cells, in contrast, are known to operate more efficiently when their incoming methanol streams are pre-heated to a predetermined temperature. Thus, heat 138 generated by equipment within the rack 102 can also be used to warm the fuel cell fluid. In order to monitor fluid temperature, temperature sensors may be provided at different locations in the fluid manifold and/or within the fuel cell device 104. The manager 118 polls these sensors for temperature data.

In FIG. 1, the first embodiment of the heat exchanger 116 is designed to function in a dual role, by both cooling equipment within the rack 102 and pre-heating the incoming methanol. As such, the first embodiment of the heat exchanger 116 surrounds the inlet conduit 130 at a location between the bypass valve 136 and the input port 120. Heat 138 is transferred to the methanol in the inlet conduit 130 by fans blowing hot air from the from the fuel cell device 104, the battery 106, the server 108, the devices 110 through 114, and the manager 118, as shown by the heat conduction arrows. How much the methanol is pre-heated by the heat exchanger 116 is preferably controlled by the manager 118 via the electrical bus 124.

In FIG. 2, the second embodiment of the heat exchanger 202 is designed only to help cool the equipment within the rack 102. As such, the second embodiment of the heat exchanger 202 surrounds a bypass conduit 204 located between the bypass valve 136 and the outlet conduit 132. In this second embodiment, the methanol is used to transfer heat 206 from equipment within the rack 102 without pre-heating the methanol passed to the fuel cell device 104.

In FIG. 3, the third embodiment of the heat exchanger 302 is designed only to help pre-heat the methanol routed to the fuel cell device 104. As such, the third embodiment of the heat exchanger 302 couples heat 304 from the very hot fluids and gases exiting the fuel cell device 104 through the outlet conduit 132 to the cool methanol passing through the inlet conduit 130.

In FIG. 4, the fourth embodiment 400 includes a mixing valve 402 instead of the bypass control valve 136. The mixing valve 402 is preferably a three-way valve having an input port, an output port, and a bypass port. The input port of the mixing valve 402 receives output fluids from the fuel cell's 104 output port 122. The output port of the mixing valve 402 connects to the fluid manifold's outlet conduit 132. The bypass port of the mixing valve 402 connects to the fluid manifold's inlet conduit 130 through bypass line 404.

The mixing valve 402 preferably mixes a predetermined portion of the higher temperature output fluid passing through the outlet conduit 132 with the lower temperature input fluid passing through the inlet conduit 130. In this fourth embodiment 400, heat is exchanged directly between the output fluids and the input fluids, thus pre-warming the input fluids. Such a embodiment 400 also transfers less waste heat to the data center fluid bus 128 which would then have to be cooled again before being routed back to the inlet conduit 130. This embodiment 400 also helps ensure that the fuel cell 104 does not run dry, even when the pump is off. An input fluid temperature control routine can be built into the manager 118 to maintain the right input fluid temperatures.

The present invention can be implemented using one or more of the heat exchangers 116, 202, and 302 depending upon the system's heating and cooling needs. The heat exchanger itself can transfer heat using heat conductive fins, cold plates, or any other heat transfer device known to those skilled in the art. In other embodiments of the present invention, the heat exchanger can be located within the fuel cell device 104 itself. Electric heaters may also be used to pre-heat the incoming methanol stream if needed, especially when the fuel cell device 104 is first being turned on. And, while methanol is used as both a fuel and coolant for the present invention, those skilled in the art will know of other fuel source fluids and gases which may also serve these dual purposes.

Cooling within the present invention may be further bolstered by adding a second coolant circuit, separate from and unrelated to the fuel cell's fluids, in order to cool the equipment within the rack 102.

Fuel cell energy production, rack cooling and methanol pre-heating are preferably controlled using a software routing operating within the fuel cell & thermal energy manager 118. The fuel cell & thermal energy manager 118 is a computer operated device which manages the fuel cell device 104, the heat exchangers 116, 202, and 302, the pump 134, and the bypass valve 136, according to the method 500 of FIG. 5.

In step 502, the manager 118 monitors the temperature of the fuel cell fluid, preferably right before the fuel cell fluid passes into the fuel cell device 104, such as at the input port 120. If the fluid temperature drops below a predetermined temperature, the manager 118, in step 504, increases the thermal energy added to the fuel cell fluid by the heat exchanger. If, however, the fluid temperature rises above a predetermined temperature, the manager 118, in step 506, decreases the thermal energy added by the heat exchanger 116 to the fuel cell fluid.

In step 508, the manager 118 monitors the rack equipment temperature. The manager 118 can obtain this information by polling the rack equipment for temperature data over the communications bus 126. If the rack equipment temperature exceeds a predetermined temperature, the manager 118, in step 510, increases the thermal energy removed from the equipment by the heat exchanger. If, however, the rack equipment temperature falls below a predetermined temperature, the manager 118, in step 512, decreases the thermal energy removed by the heat exchanger 116 from the rack equipment.

The thermal energy available for heating the fuel cell fluid and/or, removed from the rack equipment, may be modulated in a number of different ways, including: turning on an electrical heater; varying how much heat is generated by the equipment within the rack 102; varying the heat exchanger's heat transfer efficiency; turning on a supplemental cooling system; increasing an amount of air conditioned air which is passed over the heat exchanger; and/or turning off non-essential rack equipment. Steps 502 through 512 are preferably iteratively executed in parallel with steps 514 through 536.

In step 514, the manager 118 determines the rack's 102 current equipment configuration. The equipment configuration refers to a number of power consuming servers, electrical devices, and other equipment within the rack 102 and each of their individual power needs. The manager 118 can obtain this information either by polling the rack equipment over the communications bus 126, or by referring to a preloaded data table. The manager 118 also calculates its own power consumption needs. In step 516, the manager 118 transmits the rack's 102 configuration to a central computer (not shown) in the data center which controls fluid bus 128 flow throughout the data center. In step 518, the manager 118 anticipates the rack 102 equipment's power needs using the current equipment configuration information, and adjusts fuel cell fluid flow, using the pump 134 and bypass valve 136, accordingly.

In step 520, the manager 118 monitors and records the fuel cell's 104 power production. Preferably the electrical bus 124 voltage is monitored at or near the battery 106. In step 522, the manager 118 monitors and records the electrical bus 124 voltage and the power consumed by the rack's 102 equipment. If the electrical bus 124 voltage drops below a predetermined voltage, the manager 118, in step 524, increases fuel cell fluid to flow to the fuel cell device 104, either by adjusting the pump 134 or the bypass valve 136. If the electrical bus 124 voltage rises above a predetermined voltage, the manager 118, in step 526, decreases fuel cell fluid flow to the fuel cell device 104.

In step 528, rack power consumption is analyzed by the manager 118 to determine if there are any relatively predictable power consumption patterns. In step 530, the manager 118 adjusts fuel cell fluid flow to the fuel cell device in anticipation of the predicted power consumption pattern. Power consumption anticipation is preferred since fuel cells do not instantaneously vary their power output with changes in methanol flow.

If the fuel cell's 104 temperature rises above a predetermined thermal limit, the manager 118, in step 532, decreases fuel cell fluid flow to the fuel cell, thus cooling the fuel cell device 104. In step 534, the manager 118 sends a communication to the data center computer indicating any changes in fuel cell fluid flow, so that the data center computer can maintain fluid bus 122 pressure. In step 536, the manager 118, also monitors a variety of other failure mode conditions for the rack equipment, and shuts down or reroutes power to such equipment as appropriate.

While one or more embodiments of the present invention have been described, those skilled in the art will recognize that various modifications may be made. Variations upon and modifications to these embodiments are provided by the present invention, which is limited only by the following claims.

What is claimed is:

1. A system for heat exchange, comprising:
a device within a server rack having a first temperature;
fuel cell fluid having a second temperature differing from the first temperature by a temperature difference;
a fuel cell within the server rack from which electrical power can be generated;
a fluid manifold coupling the fuel cell fluid to the fuel cell; and
a heat exchanger thermally coupling the fuel cell fluid to the device, whereby the temperature difference is decreased.

2. The system of claim 1, wherein:
the first temperature is higher than the second temperature; and
the heat exchanger decreases the first temperature and increases the second temperature.

3. The system of claim 1:
wherein the fuel cell includes an input port, for receiving fuel cell fluid;
wherein the manifold includes an inlet conduit coupled to the input port; and
wherein the heat exchanger thermally couples fuel cell fluid passing through the inlet conduit to the device.

4. The system of claim 1:
wherein the fuel cell includes an output port, for exhausting fluid;
wherein the manifold includes an outlet conduit coupled to the output port; and
wherein the heat exchanger thermally couples fuel cell fluid passing through the outlet conduit to the device.

5. The system of claim 1:
wherein the fuel cell includes an input port, for receiving fuel cell fluid and an output port, for exhausting fluid;
wherein the manifold includes an inlet conduit coupled to the input port, an outlet conduit coupled to the output port, and a bypass conduit coupled between the inlet conduit and the outlet conduit; and
wherein the heat exchanger thermally couples fuel cell fluid passing through the bypass conduit to the device.

6. The system of claim 1:
wherein the fuel cell includes an input port, for receiving fuel cell fluid and an output port, for exhausting fluid;
wherein the manifold includes an inlet conduit coupled to the input port, and an outlet conduit coupled to the output port; and
wherein the heat exchanger thermally couples fuel cell fluid passing through the outlet conduit to the inlet conduit.

7. The system of claim 1, wherein:
the fuel cell fluid includes methanol; and
the fuel cell is a methanol fuel cell.

8. The system of claim 1, wherein:
the device is a server.

9. The system of claim 1, wherein:
the manifold includes a pump for maintaining a predetermined fluid pressure at the fuel cell.

10. The system of claim 1, wherein:
the manifold includes a bypass valve for maintaining a predetermined fluid pressure at the fuel cell.

11. The system of claim 1, wherein:
the manifold includes a mixing valve for maintaining the fuel cell fluid entering the fuel cell at a predetermined temperature.

12. The system of claim 1, further comprising:
an electrical bus, coupling the electrical power generated by the fuel cell to the device.

13. A system for heat exchange, comprising:
a device within a server rack having a first temperature;
fuel cell fluid having a second temperature differing from the first temperature by a temperature difference;
a methanol fuel cell within the server rack, including an input port, for receiving fuel cell fluid and an output port, for exhausting fluid, for generating electrical power;
a fluid manifold, including an inlet conduit coupled to the input port, and an outlet conduit coupled to the output port, for routing the fuel cell fluid to the fuel cell; and
a heat exchanger thermally coupling the inlet conduit to the device, whereby the temperature difference is decreased.

14. A method for heat exchange, comprising:
monitoring a device within a server rack having a first temperature;
monitoring a fuel cell fluid having a second temperature differing from the first temperature by a temperature difference;
coupling the fuel cell fluid to a fuel cell within the server rack for generating electrical power; and
exchanging thermal energy between the fuel cell fluid and the device, whereby the temperature difference is modulated.

15. The method of claim 14, wherein exchanging includes:
increasing the thermal energy transferred from the device to the fuel cell fluid, if the first temperature rises above a predetermined threshold.

16. The method of claim 14, wherein exchanging includes:
increasing the thermal energy transferred from the device to the fuel cell fluid, if the second temperature falls below a predetermined threshold.

17. The method of claim 14, wherein exchanging includes:
decreasing the thermal energy transferred from the device to the fuel cell fluid, if the first temperature falls below a predetermined threshold.

18. The method of claim 14, wherein exchanging includes:
decreasing the thermal energy transferred from the device to the fuel cell fluid, if the second temperature rises above a predetermined threshold.

19. The method of claim 14:
further comprising,
cooling the fuel cell fluid temperature below the device temperature; and
wherein exchanging includes,
cooling the device with thermal energy from the fuel cell fluid.

20. The method of claim 14:
further comprising,
raising the device temperature above the fuel cell fluid temperature; and
wherein exchanging includes,
pre-heating the fuel cell fluid with thermal energy from the device.

21. The method of claim 14, wherein monitoring a fuel cell fluid includes:
monitoring a methanol based fuel cell fluid.

22. A method for heat exchange, comprising:
monitoring fuel cell output fluid having a first temperature;
monitoring fuel cell input fluid having a second temperature differing from the first temperature by a temperature difference;
coupling the fuel cell fluid to a fuel cell within the server rack for generating electrical power; and
exchanging thermal energy between the output fuel cell fluid and the input fuel cell fluid, whereby the temperature difference is modulated.

23. A system for heat exchange, comprising a:
means for monitoring a device within a server rack having a first temperature;
means for monitoring a fuel cell fluid having a second temperature differing from the first temperature by a temperature difference;
means for coupling the fuel cell fluid to a fuel cell within the server rack for generating electrical power; and
means for exchanging thermal energy between the fuel cell fluid and the device, whereby the temperature difference is modulated.
